(19) United States
(12) Patent Application Publication
(10) Pub. No.: US 2010/0194606 A1
(43) Pub. Date: Aug. 5, 2010

(54) Method for operating a driver information system, driver information system and data carrier

(76) Inventor: Dirk Otte, Laatzen (DE)

Correspondence Address: KENYON & KENYON LLP, ONE BROADWAY, NEW YORK, NY, 10004, US

(21) Appl. No.: 12/308,340

(22) PCT Filed: Oct. 11, 2007
(86) PCT No.: PCT/EP2007/060824

§ 371 Date: Apr. 12, 2010

(51) Int. Cl. G08G 1/123

(52) U.S. Cl. 340/995.27

(57) ABSTRACT

A driver information system includes a main memory, a data carrier holding device for holding a data carrier and including a display element and at least one operating element. The data carrier has map data which are divided into planar areas or tiles, and data of different tiles having the same content stored only once on the data carrier.

### BACKGROUND OF THE INVENTION

1. Field of the Invention

The present invention relates to a driver information system, for example a navigation system, and a method for operating a driver information system in which maps, e.g., digital maps, are used, as well as a data carrier having a digital map.

2. Description of Related Art

In driver information systems, for example navigation systems for motor vehicles, digital maps are used, for example, to display a map or surroundings on a display or to enter destinations or guide the vehicle driver to a previously defined destination by outputting driving instructions, using a guidance system. The digital maps used have, for example, streets which are represented by so-called edges. Edges of this type preferably include a line element or a plurality of line elements, which may be, for example, straight, the course of an edge thereby approximating the actual course of the street. If edges meet at an intersection or a junction, these points of conjunction are represented by nodes. A network of edges and nodes thus describes, for example, the street network. The maps also have additional information, such as information on special points of interest such as restaurants, hotels or gas stations, etc.

Digital maps of this type also contain the relevant surface of the earth or a detail thereof, including data of surroundings such as rivers, lakes, or seas.

The digital maps used are ordinarily divided into so-called planar areas, which are also referred to as tiles, so that only the data of planar areas or tiles that are needed for the intended, used, or required map detail must be loaded from a data carrier into a main memory of the driver information system. By doing this, it is not necessary to load the entire map data into the main memory.

However, a disadvantage is the fact that each tile is stored on the data carrier along with its data records and is loaded into the main memory, even if it is identical to data records of other tiles. This increases the memory capacity needed on the data carrier as well as the loading time for loading the data into the main memory, and the main memory required by the driver information system must have a greater storage capacity.

### BRIEF SUMMARY OF THE INVENTION

An object of the present invention is to provide a method for operating a driver information system, a driver information system of this type and a data carrier having data of a digital map, which requires less memory capacity and has advantages in terms of loading time.

The present invention relates to a method for operating a driver information system, including a main memory, a data carrier holding device for holding a data carrier, a display element and at least one operating element, the data carrier having map data which are divided into planar areas or tiles, and data of different tiles having the same content being stored only once on the data carrier.

It is advantageous if the data carrier includes a list, table, or file of a table of contents of the data carrier in which a storage location of the particular tile on the data carrier is assigned to each tile, and data of different tiles having the same content refer to the same storage location.

The driver information system includes a main memory, a data carrier holding device for holding a data carrier, a display element and at least one operating element, the data carrier having map data which are divided into planar areas or tiles, and data of different tiles having the same content being stored only once on the data carrier.

The object with regard to the data carrier is achieved by a data carrier having map data of a digital map stored on the data carrier, the map data being divided into planar areas or tiles, map data being assigned to the tiles, the data assigned to the tiles and belonging to different tiles having the same content being stored only once on the data carrier.

It is advantageous if the data carrier is a CD, CD-ROM, DVD, memory chip, or other type of data storage medium.

### BRIEF DESCRIPTION OF THE SEVERAL VIEWS OF THE DRAWINGS

The present invention is explained in greater detail below on the basis of an exemplary embodiment with reference to the drawings.

FIG. 1 shows a schematic representation of a digital map.

FIG. 2 shows a schematic representation of a list of a table of contents of a data carrier.

FIG. 3 shows a schematic representation of a driver information system.

### DETAILED DESCRIPTION OF THE INVENTION

Driver information systems, including navigation systems, use, for example, digital maps to display the surroundings, calculate routes for reaching a selected destination point based, for example, on a current coordinate point of the vehicle on the map. For this purpose, for example, a destination coordinate is entered or defined and, on the basis of the current coordinate, the driver information system determines the most suitable route to the destination coordinate under other basic conditions which may be specified, if necessary, using an available, for example digital, map. This route may be reached using a guidance system.

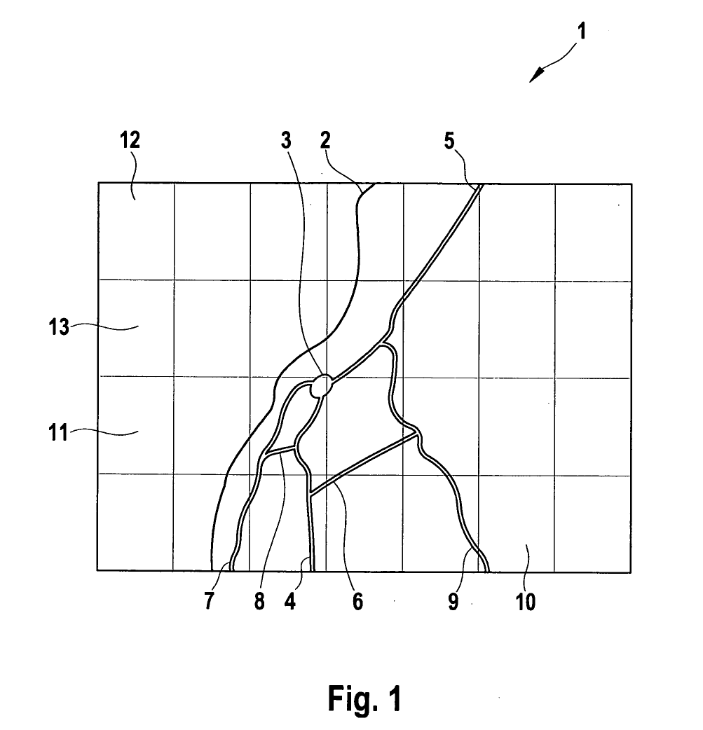

A digital map 1, which is stored on a data carrier along with its data, such as map data, is used for this purpose. FIG. 1 shows a digital map 1 of this type, or a detail of a map, which has, for example, a coastal contour 2 including a city 3 and roads 4, 5, 6, 7, 8, 9. To the right or east of coastal contour 2, land 10 is intended to be shown, and to the left or west of coastal contour 2, a lake 11 or a sea is intended to be shown. Line 2 of the coastal contour therefore represents a boundary between land and water.

Map 1 is divided into so-called planar areas 12, also referred to as tiles, the tiles being stored separately on a data carrier along with their map data assigned to these tiles, so that only the map data of one or individual or multiple tiles are loadable into a main memory of a driver information system. It is therefore not necessary to load all data of all tiles into the main memory if these data are not needed at the moment. The boundaries between the tiles may be formed by straight or also curved boundary lines, so that tiles represent, for example, rectangular planar areas of the map or planar areas of a different shape. The tiles may also be of the same size and/or be provided with different sizes. Tiles of different sizes may also be used in a map. It is also possible to use different tile sizes for different displays and/or at different resolutions.

For example, FIG. 1 shows that tiles 12 and 13 are identical because the two tiles show only water and no land.

In this case, it is advantageous according to the present invention if the data of tiles having the same content are not stored multiple times on the data carrier, but instead if the stored data of such tiles having the same content are stored only once, and these data of tiles having the same content are assigned to different tiles on the map. The advantage of this approach is that, if the data of such tiles having identical content are loaded into the main memory, these data need to be loaded only once.

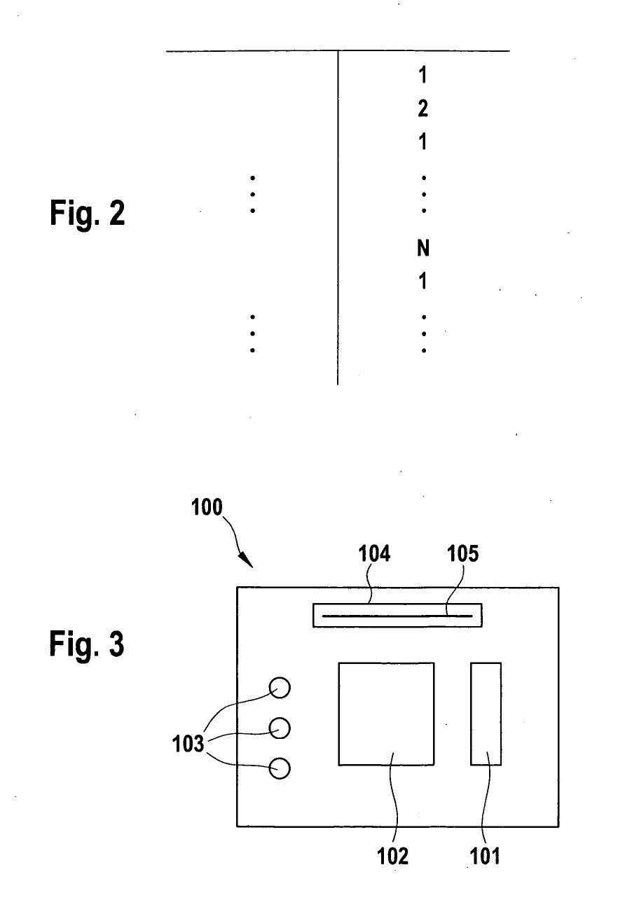

FIG. 2 shows an associated table or list having a table of contents for the tiles on the data carrier. Each tile is listed in the table of contents and each tile is assigned a storage location on the data carrier. It is apparent from FIG. 2 that storage location 1 occurs multiple times, so that tiles 1, 3 and M are identical, since they are assigned to the same storage location. If tile M is then to be loaded into the main memory of a driver information system, the data having storage location 1 are loaded. The same applies to data of tile 1 or tile 3. If a tile of this type or the associated data were thus already loaded, there would be no need to load data of an identical tile or a tile having identical content.

This means that the locations of tiles stored on the data carrier are entered for each tile in the table of contents, different entries being provided for different tiles having identical content which, however, refer to the same entry for the storage location.

FIG. 3 shows a schematic representation of a driver information system 100, for example a navigation system, including a main memory 101, a display element 102 such as a display and at least one operating element 103. Navigation system 100 is able to display map representations on display element 102, it being possible to display, for example, calculated routes in a map representation. Navigation system 100 also includes a data carrier holding device 104, which may be used to provide or hold a data carrier 105 on which digital map data are stored. A driver information system 100 according to FIG. 3 may be used to carry out the methods described above.

1-5. (canceled)

6. A method for operating a driver information system having a display screen, comprising:
providing a data-carrier holding device; and
providing a computer-readable data carrier adapted to be held in the data-carrier holding device;
wherein the computer-readable data carrier stores map data assigned to a plurality of planar tile areas to be displayed on the display screen of the driver information system, and wherein in the case a selected datum is assigned to multiple different tile areas, the selected datum is stored only once on the data carrier.

7. The method as recited in claim 6, wherein the data carrier stores a list of storage locations of the data associated with each tile area, and wherein in the case a selected datum is assigned to multiple different tile areas, the list of storage locations refers to one storage location for the selected datum.

8. A driver information system, comprising;
a display screen;
a main memory;
a data-carrier holding device; and
a computer-readable data carrier adapted to be held in the data-carrier holding device;
wherein the computer-readable data carrier stores map data assigned to a plurality of planar tile areas to be displayed on the display screen of the driver information system, and wherein in the case a selected datum is assigned to multiple different tile areas, the selected datum is stored only once on the data carrier.

9. A computer-readable data carrier, comprising:
storage areas for storing map data assigned to a plurality of planar tile areas to be displayed on a display screen of the driver information system;
wherein in the case a selected datum is assigned to multiple different tile areas, the selected datum is stored in only one storage location.

10. The computer-readable data carrier as recited in claim 9, wherein the computer-readable data carrier is one of a CD, a CD-ROM, a DVD, and a memory chip.
